(19) United States
(12) Patent Application Publication
(10) Pub. No.: US 2026/0202300 A1
(43) Pub. Date: Jul. 16, 2026

(54) HOLOGRAPHIC OPTICAL SYSTEM AND METHOD FOR AUTOMATIC IMAGING AND INTERPRETATION OF MICROBIOLOGICAL SAMPLES

(71) Applicant: Macula Vision Systems, Inc., Tucson, AZ (US)

(72) Inventors: Richard Stahl, Rotselaar (BE); Alena Shamsheyeva, Tucson, AZ (US); Kyle Spafford, Austin, TX (US); Oleg Gusyatin, Tucson, AZ (US)

(73) Assignee: Macula Vision Systems, Inc., Tucson, AZ (US)

(21) Appl. No.: 19/135,264

(22) PCT Filed: Dec. 5, 2023
(86) PCT No.: PCT/US2023/082560

§ 371 Date: Jun. 3, 2025

Related U.S. Application Data
(60) Provisional application No. 63/430,235, filed on Dec. 5, 2022.

(51) Int. Cl. G01N 15/0227; G01N 15/02; G01N 15/10; G01N 15/14; G01N 15/1434; G01N 21/45; G03H 1/00; G03H 1/04; G03H 1/08

(52) U.S. Cl. CPC G01N 15/0227; G01N 15/1434; G01N 21/453; G03H 1/0443; G03H 1/0866; G01N 2015/0294; G01N 2015/1006; G01N 2015/1454; G01N 2015/1493; G01N 2015/1497; G03H 2001/005; G03H 2001/0447

(57) ABSTRACT

An imaging system (100) is provided for in-line holographic imaging of a biological sample (12) on a sample carrier (10) for automated generation of representations of the biological sample (12) for infection analysis. The imaging system (100) comprises: one or more light sources (110, 112, 114) configured to generate illumination light of at least three different wavelengths and configured to illuminate the biological sample (12) in an imaging position; a photo-sensitive detector (120) configured to detect a plurality of interference patterns (122), wherein each of the plurality of interference patterns (122) is based on a respective wavelength of the at least three different wavelengths; and a processor (130), which is configured to combine information of the interference patterns (122) based on known spectral characteristics of illumination light for improving resolution compared to individual interference patterns (122) and generate multi-spectral representation of the biological sample (12) with the improved resolution.

### TECHNICAL FIELD

The present inventive concept relates to an imaging system and a method for in-line holographic imaging of a biological sample. In particular, the present inventive concept relates to automated generation of representations of the biological sample.

### BACKGROUND

Clinical microbiology laboratories have long relied on a simple but effective approach to confirming and characterizing an infection of a human or animal patient, namely microscopic examination of a sample smear. Sample smears vary in preparation technique, including dry or wet mounts on a microscopic slide, and usually include a contrast enhancing staining procedure that is selected based on type of suspected microorganism causing the infection. The most common staining procedure used in clinical microbiological laboratories is the Gram stain. In fact, Gram stain is typically used as a first objective assessment of state of the infection of the patient, preceding further diagnostics to be made of the state of the infection. For this reason, the preparation and interpretation of the Gram stained smear by a trained clinical laboratory scientist (CLS) needs to be reliable, accurate, and timely. Typically, a full report should be available in less than 90 minutes for an acute setting, and in less than 3 hours for a routine setting.

Whether the origin of the sample is a positive blood culture, sputum, wound swab, or a normally sterile bodily fluid, performing the technique of smear preparation with contrast enhancing stain takes relatively little time or training. Larger laboratories, where sample volumes are high, often resort to automated staining instruments which are widely available. However, the portion of the procedure which requires most training and which is most time intensive is interpretation via review under the microscope. Using a brightfield microscope, a trained CLS is required to find, focus, and review dozens of fields of view under varying optical magnifications, including those requiring oil-immersion objectives.

Due to the increasing sample volumes in centralized laboratories as well as worsening labor shortages in the field, a CLS is required to review and interpret more slides per shift on average. In addition, Gram stained slides are often interpreted by generalists with less than adequate microbiology training. This may lead to intra-operator variability as well as the overall degradation of interpretation accuracy, which, in turn, has a potentially adverse effect on the treatment of the patient.

The increasing burden on the CLS during the interpretation portion may be eased by automation of imaging of the microscopic slide. However, automated systems for imaging of whole microscopic slides are expensive, occupy valuable laboratory bench space, and still take a significant amount of time to scan a slide at required resolution.

Similar constraints apply to interpretation by a cytotechnologist or cytopathologist of tissue and cytology samples collected using needle biopsy, fine needle aspirates (FNAs), endoscopic biopsy, surgical biopsy, brush biopsy, or washings.

### SUMMARY

An objective of the present inventive concept is to mitigate, alleviate or eliminate one or more of the above-identified deficiencies in the art and disadvantages singly or in any combination. In particular, an objective of the present inventive concept is to provide an imaging system and a method for imaging of a biological sample which can generate representations of the biological sample in a fast manner using a compact system.

These and other objectives are at least partly achieved by the invention as defined in the independent claims. Preferred embodiments are set out in the dependent claims.

According to a first aspect, there is provided an imaging system for in-line holographic imaging of a biological sample on a sample carrier for automated generation of a representation of the biological sample for phenotypic analysis of a pathological process, the imaging system comprising: one or more light sources configured to generate illumination light of at least three different wavelengths; a receptacle for receiving the sample carrier in an imaging position; wherein the one or more light sources are configured to illuminate the biological sample by the generated illumination light in the imaging position; a photo-sensitive detector configured to detect a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and a processor, which is configured to receive the plurality of interference patterns, wherein the processor is configured to combine information of the interference patterns based on known spectral characteristics of illumination light for improving resolution compared to individual interference patterns and generate multi-spectral representation of the biological sample with the improved resolution.

Thanks to using in-line holographic imaging, a wide field of view may be imaged. Since the system does not need a (magnifying) imaging lens, a field of view is only limited by an area of the photo-sensitive detector. Thus, in comparison to imaging systems using an imaging lens, the present imaging system for in-line holographic imaging does not have an inverse relationship between field of view and spatial resolution.

Thus, the use of in-line holographic imaging allows at least a large portion of the biological sample carried by the sample carrier to be imaged simultaneously. This implies that substantive repositioning of the sample carrier may be avoided.

According to an embodiment of the first aspect, the imaging system is used for automated generation of a representation of the biological sample for infection analysis.

In other words, according to the embodiment, there is provided an imaging system for in-line holographic imaging of a biological sample on a sample carrier for automated generation of a representation of the biological sample for infection analysis, the imaging system comprising: one or more light sources configured to generate illumination light of at least three different wavelengths; a receptacle for receiving the sample carrier in an imaging position; wherein the one or more light sources are configured to illuminate the biological sample by the generated illumination light in the imaging position; a photo-sensitive detector configured to detect a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and a processor, which is configured to receive the plurality of interference patterns, wherein the processor is configured to combine information of the interference patterns based on known spectral characteristics of illumination light for improving resolution compared to individual interference patterns and generate multi-spectral representation of the biological sample with the improved resolution.

Since common analyses of biological samples for infection analysis involve review of numerous fields of view of the biological sample from different parts of the sample, the imaging system facilitates substantially decreasing a necessary time for acquiring images for review for infection analysis.

Further, the imaging system allows analysis of a large overall area of the biological sample compared to common analyses, since review of several fields of view as used in common analyses may imply that, in practice, the number of fields of view are limited and the overall area being reviewed is small. Thanks to providing analysis of the large overall area implies that there is a higher chance of discovering bacteria or other cells of interest, especially at low concentrations of the bacteria or other cells.

Thus, the imaging system provides specific advantages for facilitating infection analysis.

However, it should be realized that the imaging system may also advantageously be used for automated generation of a representation of the biological sample for other types of analyses. For instance, the imaging system may provide representations of the biological sample suitable for pathological analysis, such as for facilitating cancer diagnosis. Such pathological analysis may also benefit from the imaging system enabling review of a large area of the sample.

Also, the use of in-line holographic imaging implies that separate acquisitions of images of the sample using different magnifications is not necessary. Rather, the in-line holographic imaging allows the biological sample to be imaged with a resolution which is at least comparable to a brightfield microscope. This high resolution imaging of the biological sample is further obtained while a large field of view of the biological sample may be imaged simultaneously.

According to an embodiment, the imaging system is adapted to provide imaging of biological samples for infection analysis. Thus, the imaging system is configured to generate representations of the biological sample that may be used in determining an analysis of the biological sample to reduce a time spent by a CLS on obtaining images of the biological sample to be reviewed. Hence, the imaging system addresses a time consuming act in infection analysis to facilitate increasing throughput of analysis results from a clinical microbiology laboratory. Thanks to advances in sensor technology, processors, and control electronics, the imaging system may be developed such that it may increase throughput from a clinical microbiology laboratory using an inexpensive and compact imaging system.

It should be realized that the imaging system may also or alternatively be adapted for imaging of biological samples for other types of analyses. The imaging system may facilitate increasing throughput of analysis results also for such other types of analyses. Further, it should be realized that, in particular for other types of analyses not related to infection analysis, the analysis may not necessarily be performed by a CLS but may rather be performed by another operator. Thus, when reference is made to a CLS herein, it should be realized that the imaging system may alternatively be used by another type of operator who may not necessarily be a CLS.

It should further be realized that the automated generation of the representation of the biological sample may be presented to an operator, such as a CLS, for facilitating the analysis to be performed by the operator. However, the imaging system may also or alternatively be configured to provide further information based on processing of the representation of the biological sample, such that an automated interpretation of the biological sample may be provided.

The imaging system may be configured to generate representations of the biological sample that may be adapted for display to the CLS or another operator. Thus, the imaging system may be configured to generate images that may be presented on a display. In this regard, the imaging system may be configured to generate the image(s) needed to be reviewed by the CLS. Hence, the CLS may be quickly presented with the image(s) to be reviewed and the CLS may then review the image(s) in order to perform analysis of the biological sample.

However, it should be realized that the generated representations of the biological sample need not necessarily be adapted for display to the CLS or another operator. Rather, the generated representations may be in form of processed interference patterns which may not be fully reconstructed into a corresponding visual image of the biological sample. The generated representations may still allow analysis of the biological sample to be performed, although not through a conventional visual review by the CLS. The generated representations may be analyzed by further image processing, e.g., by the processor, such that automated interpretation in form of an analysis result or an intermediate analysis result may be provided without need of action by the CLS or another human reviewer. It should be realized that a processor that performs image processing in order to analyze content need not necessarily do so based on a representation of the biological sample that may be visually presented on a display.

The imaging system is configured to provide a multi-spectral representation of the biological sample. Thus, the imaging system facilitates analysis of the biological sample using information of a plurality of spectral ranges. This facilitates providing a representation that may be presented to a CLS or another operator in a manner corresponding to images that the CLS (or other operator) is used to analyze using a conventional microscope. The multi-spectral representation may involve three wavelengths, which could allow a full color representation of the biological sample (e.g., using an RGB color representation). However, it should be realized that even more wavelengths may be used.

The imaging system is configured to use spectral characteristics of the illumination light in processing the detected plurality of interference patterns. The different wavelengths of the illumination light may provide a phase diversity in interference of the illumination light with the biological sample. By using knowledge of the spectral characteristics of the illumination light, the phase diversity may be taken into account and may be used for combining information of the interference patterns into a representation of the biological sample, wherein spatial resolution is improved. In particular, the knowledge of spectral characteristics may be used for removing twin image noise. Twin image noise is caused by acquisition of an interference pattern only providing an intensity of light such that phase information is lost. When performing image reconstruction, the loss of phase information leads to two indistinguishable solutions of a complex wave equation, forming twin image noise.

Hence, thanks to the use of information of spectral characteristics of the illumination light, spatial resolution of the representation of the biological sample may be improved since reduction of image quality due to loss of phase information may be avoided.

It should further be realized that the type of biological sample may be known to the imaging system. Thus, optical characteristics of the biological sample may be known, which may facilitate processing of the interference patterns. Hence, it should be realized that known spectral characteristics of the illumination light may also relate to known characteristics of interaction of the illumination light with the biological sample.

A desired resolution of the representation of the biological sample may be dependent on a size of objects of interest in the biological sample. Thus, the processor may further be configured to process the received interference patterns so as to provide a suitable resolution of the representation of the biological sample, which resolution is adapted to the biological sample. For instance, if the biological sample is expected to comprise bacterial cells, a higher resolution of the representation of the biological sample may be desired compared to if the biological sample is expected to comprise eukaryotic cells.

It should further be realized that the imaging system may be configured to control illumination light, such that characteristics of the illumination light, such as the wavelength of illumination light used, may be adapted to the biological sample to be imaged.

It should be realized that different angles of incidence of the illumination light of different wavelengths may also be used for further increasing phase diversity of the detected interference patterns. In this regard, the processor may be configured to combine information of the interference patterns based on known spectral characteristics of illumination light and known angular relations between illumination light and the biological sample (i.e., the angular relation between illumination light and a normal to a plane in the imaging position, wherein the receptacle may define the plane in the imaging position).

The use of the different wavelengths may thus allow acquisition of phase information of the biological sample. This phase information may be used for determining a volume of an object of the biological sample providing additional information for analysis of the biological sample.

The use of a plurality of illumination wavelengths may allow a high quality multi-spectral representation of the biological sample to be formed. It should be realized that a color representation of an image to be displayed may normally be formed using three color channels, e.g., by means of an RGB representation using red (R), green (G), and blue (B) channels. The color representation may span a portion of a color space. The plurality of illumination wavelengths may be used for improving color representation such that a spectral resolution of the representation of the biological sample may be improved.

It should further be realized that the illumination wavelengths used may be adapted to the type of biological sample. For instance, if a particular coloring or stain of the biological sample is used, the illumination wavelengths may be adapted to such color of the biological sample. The imaging system may be configured to automatically detect information of the biological sample in an initial processing step before initiating automated generation of the representation of the biological sample. Additionally or alternatively, the imaging system may receive information relating to the biological sample through manual input. The imaging system may be configured to select or tune illumination wavelengths to be used based on such information relating to the biological sample. The imaging system may also be configured to control processing of the biological sample to provide a resolution of the representation of the biological sample that fits the type of biological sample.

The use of the at least three different wavelengths allows acquiring a representation of the biological sample with a sufficient spatial resolution for performing further phenotypic analysis of a pathological process of the biological sample, such as for infection analysis. Also, the use of the at least three different wavelengths allows acquiring spectral information such that a spectral resolution may be acquired corresponding to conventional microscopy imaging of biological samples.

Hence, diversity in wavelengths is used both for providing a high quality spatial resolution and a high quality spectral resolution. For instance, using only a limited number of detected interference patterns, a representation of the biological sample may be obtained which corresponds to or outperforms quality of microscopic imaging (while providing imaging of a much larger field of view). Thus, using not more than ten wavelengths, such as not more than five wavelengths, the imaging system may acquire interference patterns that may be combined into a multi-spectral representation of the biological sample that corresponds to or outperforms quality of color microscopic imaging. It should however be realized that quality of the representation may still be sufficient using even fewer wavelengths, such as only three different wavelengths.

Further, the different wavelengths to be used may be adapted to a particular type of phenotypic analysis of a pathological process of the biological sample, such as a particular type of infection analysis to be made. Thus, if the imaging system is to be used with a particular staining of the biological sample, the illumination light may include a wavelength that corresponds to a color of the staining such that strong interaction between the illumination light and the stain may be provided.

As used herein, the term “in-line holographic imaging” should be construed as an imaging of an object, wherein the object, for at least some of the at least three different wavelengths, is relatively transparent or involves particles that are sparsely arranged such that illumination light is allowed to pass through the object without being affected by the object, forming non-scattered illumination light. Further, the imaging of the object involves illumination light being scattered by the object such that the scattered illumination light and non-scattered illumination light form an interference pattern which may be detected.

The biological sample may be at least one of the following: blood, plasma, serum, sputum, saliva, bronchoalveolar lavage fluid, lymph, urine, stool, pleural fluid, ascites fluid, synovial fluid, fluid obtained by irrigating or washing a body cavity, needle biopsy, fine needle aspirates (FNAs), endoscopic biopsy, surgical biopsy, and brush biopsy.

The object may absorb a substantial amount of light for at least one of the at least three different wavelengths. Absorbance of light may be part of a color signature of the object, such that the photo-sensitive detector may be configured to detect a low intensity of light for wavelength(s) where the object has a high absorbance. This may be further used in the multi-spectral representation of the biological sample and may provide important information for allowing analysis of the biological sample.

The term “sample carrier” should be construed as any arrangement which may hold a sample, such as a microscopic slide or a Petri dish. The sample carrier may provide a substrate surface on which the biological sample is received. The sample carrier may further comprise walls defining a well or an otherwise defined space in which the biological sample may be received and held. Further, the sample carrier may be configured with a lid or cover which may be arranged on an opposite side of the biological sample to the substrate surface. This may be used such that the biological sample may be confined to a closed space. The sample carrier may be configured to allow a biological sample to be prepared externally to the imaging system and to be presented to the imaging system after the biological sample has been prepared and is carried by the sample carrier. Alternatively, the sample carrier may be arranged to receive the biological sample when arranged in the imaging system.

The term “automated generation” should be construed such that the imaging system allows representation of the biological sample to be generated without need of human intervention. Hence, once the biological sample is ready to be imaged, the imaging system may generate representations of the biological sample without any need of input from an operator. Thus, the imaging system may illuminate the biological sample, detect interference patterns, and output a representation of the biological sample that may be used for phenotypic analysis of a pathological process of the biological sample, such as for infection analysis. However, it should be realized that human intervention may still be allowed, such as to request an image of a particular portion of the biological sample to be generated from an overall image of the biological sample and presented on a display.

The term “representation of the biological sample” should be construed as any representation of the biological sample that is based on detection of interference patterns. Hence, the representation may be based on a combination of interference patterns, i.e., intensity of detected light based on interference of scattered illumination light and non-scattered illumination light. The representation may alternatively be based on reconstruction of the biological sample using the plurality of interference patterns. This may correspond to an image of the biological sample which may be presented and be visually understood by a human being. Further, the representation may be based on partial reconstruction of the biological sample involving retrieval of phase information, which partial reconstruction may or may not be suited for visual presentation. Phase and intensity retrieval may be conducted in multiple focal planes, which may be used simultaneously for purposes of generating in-focus representation of an inherently three-dimensional sample. Thus, the representation of the biological sample may provide information relating to three dimensions of the biological sample. One or more focal plane may be selected for output (such as sequential output of different focal planes) for forming the representation of the biological sample. For instance, the multiple focal planes may span a thickness of the biological sample of at least 100 micrometers.

It should be further realized that the representation of the biological sample may be further processed for analysis of the biological sample. This analysis may provide an automated interpretation of the biological sample. Such automated interpretation may refer to the processor being configured to process the representation of the biological sample for automatically detecting objects of pathological interest from the representation of the sample. Further, the processor may be configured to classify the detected objects into respective groups that include but are not limited to bacterial cells, fungal cells, red blood cells, white blood cells, platelets, squamous cells, epithelial cells, polymorphonuclear neutrophil cells, protozoa, ova, parasites, or combinations thereof. The automated interpretation may provide a result based on classification of the detected objects, such as an indication of presence of particular category or categories of detected objects. The automated interpretation may further provide a result based on a further determination using the classification of the detected objects and/or numbers of objects of respective category or categories. Thus, the automated interpretation may involve an automated pathological determination using the cell categories detected in the sample.

The term “phenotypic analysis of a pathological process” should be construed as meaning any type of analysis related to a pathological process. Thus, the representation of the biological sample may provide information that provides observable characteristics of the pathological process. The analysis may provide information relating to a disease, such as providing an indication of a cause of a disease or information relating to a diagnosis to be made. For instance, the pathological process may relate to a process that is based on an infection, such that the analysis may relate to an infection analysis, such as relating to classifying a type of infection. The pathological process may alternatively relate to a neoplastic process, such as relating to determination of a cancerous disease.

The biological sample may be blood such that a hematological analysis may be provided. For instance, the representation of the biological sample may be used for classifying and/or counting cell types in a blood sample, such as counting number of leukocytes, differential leukocyte counts, which may provide direct information for determining a pathological process or may provide an indirect indication that a pathological process is ongoing. Thus, the representation of the biological sample may in embodiments provide a representation of a blood sample, that may allow direct or indirect analysis of a pathological process.

The biological sample may be stool such that an ova and parasite analysis may be provided. For instance, the representation of the biological sample may be used for classifying and/or counting ova and parasite types in a stool sample, such as counting number of ova and parasites, which may provide direct information for determining a pathological process or may provide an indirect indication that a pathological process is ongoing. Thus, the representation of the biological sample may in embodiments provide a representation of a stool sample, that may allow direct or indirect analysis of a pathological process.

The biological sample may be sputum such that acid-fast bacteria infection analysis may be provided. For instance, the representation of the biological sample may be used for counting mycobacteria in a sputum sample stain with AFB stain, which may provide direct information for determining a pathological process or may provide an indirect indication that a pathological process is ongoing. Thus, the representation of the biological sample may in embodiments provide a representation of a sputum sample, that may allow direct or indirect analysis of a pathological process.

The representation of the biological sample may provide observable characteristics for performing analysis of the pathological process. The analysis to be performed may be automated in that the processor may process the representation of the biological sample to provide an automated interpretation of the biological sample. The analysis may alternatively be partly automated in that the processor may process the representation of the biological sample to provide an automated intermediate interpretation of the biological sample which may be further manually analyzed in order to arrive at an analysis of the pathological process. The analysis may, according to another alternative, be entirely manually performed based on the representation of the biological sample provided by the imaging system.

The “light source” may be a light source configured to output at least partially spatially coherent light. The at least partially spatially coherent light may have a coherence length corresponding to at least a distance between the imaging position and the photo-sensitive detector. The light source may for instance be a laser light source or another light source, such as a light emitting diode (LED), which is combined with a pinhole to provide spatial coherence of light having passed the pinhole. It should also be realized that, if a plurality of light sources is used, the light sources need not be of a same type. Thus, a plurality of light sources may comprise a laser light source and a LED light source combined with a pinhole.

The light source may have a well-defined wavelength, such that a wavelength of the illumination light is well-defined. For instance, a bandwidth of a full-width half maximum (FWHM) of the light may be less than 50 nm. The three different wavelengths may be distinct, such that the FWHM of different wavelengths does not overlap. However, if more than three different wavelengths are used, there may be an overlap between wavelengths even though three wavelengths for which the FWHM does not overlap may still be selected among the illumination wavelengths.

The imaging system may comprise a single light source which may be tuned in order to output the three different wavelengths. Alternatively, a light source among a plurality of light sources may be tuned to provide more than one wavelength, even though the imaging system still comprises more than one light source. As yet another alternative, the imaging system may comprise a plurality of light sources wherein each light source is dedicated to output a single wavelength among the different wavelengths.

The photo-sensitive detector may comprise a two-dimensional array of photo-sensitive areas, wherein each photo-sensitive area is configured to detect an intensity of light incident on the photo-sensitive area. The photo-sensitive detector may thus be configured to detect a two-dimensional distribution of light for detecting an interference pattern.

The one or more light sources may be configured to sequentially illuminate the biological sample. This implies that the photo-sensitive detector may detect each interference pattern using all of the photo-sensitive areas. However, the biological sample may alternatively be illuminated using two or more wavelengths simultaneously. Different photo-sensitive areas may then be configured to detect different wavelengths, such that the photo-sensitive areas may be grouped in macro-pixels comprising a plurality of photo-sensitive areas, wherein, for each of the wavelengths of simultaneous illumination, the plurality of photo-sensitive areas comprise at least one photo-sensitive area dedicated to detecting the wavelength. The macro-pixels may further be repeated in an array of micro-pixels over the area of the photo-sensitive areas. Hence, the photo-sensitive detector may be configured to simultaneously detect interference patterns of two or more wavelengths, albeit with a lower resolution than if a single interference pattern at a time is detected.

The term “receptacle” should be construed as any arrangement which may receive and define a position of the sample carrier. Thus, the receptacle may be configured to provide a supporting surface for receiving the sample carrier. The receptacle may comprise a hole or a transparent portion in the supporting surface for allowing light to pass between the biological sample and the photo-sensitive detector. The receptacle may provide support for receiving the sample carrier in the imaging position. However, the receptacle may alternatively be movable between a receiving position, in which the receptacle may be arranged to facilitate placing of the sample carrier in the receptacle, and the imaging position. This may facilitate handling of the sample carrier by the operator of the imaging system, while allowing the biological sample to be illuminated in an imaging position within a housing of the imaging system.

The processor may be any unit which is configured to process information. The processor may be a general-purpose processing unit, such as a central processing unit (CPU) or a graphical processing unit (GPU), which may be provided with instructions, e.g., through computer software, for controlling the general-purpose processing unit to process the plurality of interference patterns. However, the processor may alternatively be implemented as firmware arranged e.g., in an embedded system, or as a specifically designed processor, such as an Application-Specific Integrated Circuit (ASIC) or a Field-Programmable Gate Array (FPGA).

The processor may be arranged in a common housing with the light source(s), the receptacle, and the photo-sensitive detector. However, the processor may alternatively be arranged externally to a housing in which the other components are arranged. In such case, the processor may be configured to communicate with a communication unit in the housing for receiving the detected interference patterns from the photo-sensitive detector. The processor may also be distributed between different units, such that processing of the detected interference patterns may take place partly within the housing and partly externally to the housing. It should be realized that the processor may thus be arranged anywhere, such as even being arranged “in the cloud”.

The known spectral characteristics of illumination light implies that wavelength of light is known such that propagation of the illumination light may be computed. This may be used in combination with knowledge of an angle of the illumination light in relation to the plane in the imaging position (if different angles are used) in order to allow the detected plurality of interference patterns to be combined in an iterative phase retrieval.

The spatial resolution of the generated multi-spectral representation may be improved in relation to an individual interference pattern of the plurality of interference patterns. Further, a spectral resolution of a plurality of interference patterns for providing a spectrally resolved representation of the biological sample may be improved by addition of another interference pattern using another wavelength. Thus, wavelength diversity among a plurality of wavelengths may be used for improving spatial resolution and/or spectral resolution of the generated multi-spectral representation.

The multi-spectral representation of the biological sample comprises information of the biological sample for at least two wavelengths. The multi-spectral representation may provide information for each spectral channel corresponding to the wavelengths of illumination light. However, a number of spectral channels in the multi-spectral representation may be smaller than the number of wavelengths of illumination light.

According to an embodiment, the processor is configured to combine information of the interference patterns based on known spectral characteristics of illumination light for improving spatial and spectral resolution.

This implies that the multi-spectral representation of the biological sample may provide a high quality representation of the biological sample in both spatial and spectral domain. This may facilitate correct analysis of the biological sample.

According to an embodiment, the one or more light sources are configured to generate illumination light of a number of wavelengths being at least five wavelengths and wherein the processor is configured to generate multi-spectral representation of the biological sample including fewer wavelengths than the number of wavelengths of the illumination light.

The imaging system may be configured to detect one interference pattern per field of view for each wavelength. The number of wavelengths and spectral characteristics may be configured to allow the imaging system to use as few wavelengths as possible while allowing a high quality representation of the biological sample to be acquired.

While the imaging system may generate an adequate representation of the biological sample using three different wavelengths, the imaging system may be configured to provide high quality spectral and spatial resolution of the multi-spectral representation of the biological sample when using at least five wavelengths. For instance, for infection analysis of Gram stain samples, a CLS conventionally uses images with high spectral information. Thus, the use of at least five wavelengths may provide sufficient spectral information to allow corresponding quality of representation of the biological sample.

According to an embodiment, the imaging system is configured to generate a plurality of multi-spectral representations for a plurality of fields of view of the biological sample.

This implies that the imaging system is configured to generate representations for a plurality of fields of view. Even though the imaging system allows a large field of view to be imaged simultaneously using in-line holographic imaging, an entire biological sample, e.g., arranged on a microscopic slide, may not necessarily be imaged within a single field of view.

The imaging system may be configured to generate the plurality of multi-spectral representations representing the plurality of fields of view in an automated manner requiring no human intervention. This implies that the imaging system may quickly and easily provide representation of the entire biological sample.

According to an embodiment, the photo-sensitive detector comprises an array of sensors, wherein each sensor in the array is configured to detect the plurality of interference patterns for a respective field of view of the biological sample.

This implies that the photo-sensitive detector may provide sensors working in parallel, which may each be configured to image a respective field of view. It should be realized that each sensor may in turn comprise an array of photo-sensitive areas for detecting the interference pattern at the sensor.

The array of sensors allows the plurality of interference patterns for the respective fields of view to be simultaneously detected such that the plurality of fields of view may be simultaneously imaged. This facilitates providing a very fast imaging of the entire biological sample. Further, no moving parts may be needed in order to allow the entire biological sample to be imaged.

Each sensor in the array may be associated with a respective light source or a respective set of one or more light sources. However, two or more sensors in the array of sensors may alternatively share a common set of one or more light sources.

According to another embodiment, the imaging system further comprises a mechanical scanning stage for causing a relative movement between the biological sample and the photo-sensitive detector for detecting the plurality of interference patterns for a plurality of fields of view.

The mechanical scanning stage may be used for moving the biological sample and the photo-sensitive detector between imaging of different fields of view. Thus, a first field of view may first be imaged to generate a multi-spectral representation of the first field of view. Then, the mechanical scanning stage may be activated, and a second field of view may be imaged to generate a multi-spectral representation of the second field of view.

The mechanical scanning stage may be provided with automated control such that no human intervention may be necessary in order for the imaging system to provide imaging of the plurality of fields of view.

The mechanical scanning stage may be configured to move the biological sample, e.g., by moving the receptacle or by moving the sample carrier in the receptacle, or may be configured to move the photo-sensitive detector, or may be configured to move both.

According to an embodiment, the processor is configured to reconstruct a multi-spectral image of the biological sample.

This implies that the imaging system provides an image that may be displayed and reviewed by the operator, such as a CLS. Thus, the imaging system may for example be configured to quickly generate the multi-spectral image that is needed by the CLS for analyzing the biological sample for infections.

According to an embodiment, the processor is further configured to generate a plurality of high-power fields of view for presentation to an operator.

This may be particularly suitable for infection analysis but may also be used in other types of analysis of pathological processes.

Infection analysis is typically based on review of a plurality of portions of a biological sample. Thanks to the processor generating a plurality of fields of view, the imaging system may be configured to generate all the fields of view needed in order for the operator to be able to perform infection analysis. Thus, the imaging system may substantially reduce the amount of time required for otherwise time consuming acquisition of the necessary images for performing infection analysis.

The fields of view may for instance have a size corresponding to representing 180 μm*180 μm of the sample, which is commonly used in manual analysis by a CLS.

The fields of view may be high-power in that the fields of view represent the biological sample corresponding to a high magnification power, such as a magnification of at least 40 times, at least 100 times, at least 400 times, or at least 1000 times.

According to an embodiment, the processor is configured to process the representation of the biological sample for verifying a quality of the biological sample.

This implies that the imaging system may verify quality of the biological sample, such that biological samples of inadequate quality may be automatically rejected. Hence, biological samples of inadequate quality may not need to be considered by the operator or the inadequate quality may be quickly confirmed by the operator. This may enable reduction of time spent on analysis of biological samples for which a reliable analysis result may anyway not be possible to achieve.

The quality of the biological sample may for example be verified in relation to conditions during which a human CLS will not be able to perform infection analysis. Inadequate quality of the biological sample may occur e.g., when the biological sample comprises insufficient amount of biological material, e.g., because of poor smear preparation. Inadequate quality may also occur when the biological sample is too concentrated, e.g., comprising an excessive amount of host cells or mucus. In each of these conditions, a human CLS would reject the biological sample.

The imaging system may be configured to verify the quality of the biological sample based on processing of an image reconstructed from the plurality of interference patterns. However, it should be realized that the conditions of inadequate quality may result in a too small signal or a too large signal, such that the processor may be configured to verify quality of the biological sample by directly comparing intensity or distribution of intensity of the plurality of interference patterns to one or more thresholds.

This implies that the quality of the biological sample may be verified before substantial processing of the plurality of interference patterns is initiated such that the imaging system may very quickly verify inadequate quality of the biological sample. Hence, processing resources and time may not need to be spent on biological samples of inadequate quality.

According to an embodiment, the processor is configured to process the multi-spectral representation of the biological sample for verifying a quality of staining of the biological sample.

The quality of staining may be verified in relation to conditions during which a human operator will not be able to perform analysis of the biological sample, such as a human CLS not being able to perform infection analysis. The imaging system may be configured to store calibration information relating to acceptable spectral information of the biological sample for the staining being used. If the imaging system is configured to be used with different staining of the biological sample, the processor may be configured to select and access the relevant calibration information.

The processor may be configured to compare the spectral content of the multi-spectral representation of the biological sample to the calibration information. If there is a deviation in expected spectral content, the processor may indicate that quality of staining is inadequate. This may be used for quickly rejecting the biological sample if the quality of staining prevents a reliable analysis, such as a reliable infection analysis, to be made. The imaging system may be configured to reject the biological sample, such that the biological sample need not be considered by the operator or the inadequate quality of staining may be quickly confirmed by the operator. This may enable reduction of time spent on analysis of biological samples for which a reliable analysis result may anyway not be possible to achieve.

For instance, the verifying of the quality of staining may identify that an insufficient amount of stain has been deposited on or within cellular membranes of the biological sample.

According to an embodiment, the imaging system is configured to generate representations of the biological sample for imaging of the biological sample using staining of the biological sample.

This implies that the imaging system may be specifically adapted, for example, for infection analysis using a particular staining of the biological sample. The one or more light sources of the imaging system may be configured to generate illumination light particularly suited for analysis of the particular staining of the biological sample.

For instance, the imaging system may be specifically adapted for infection analysis using Gram staining of the biological sample. Thus, the at least three different wavelengths may comprise a wavelength at approximately 590 nm.

The imaging system may be adapted for a single type of staining of biological samples for infection analysis, such that the imaging system may be solely used for such staining. Hence, the imaging system may for example be dedicated for use with Gram staining of the biological sample.

Alternatively, the imaging system may be configured to be used with different types of infection analyses. In this regard, the imaging system could be configured to adapt the imaging of the biological sample based on the type of staining of the biological sample to be imaged. For instance, the imaging system may be configured to select different wavelengths for illumination of the biological sample in dependence of the type of staining.

The imaging system may be configured to be specifically adapted to imaging of biological samples using staining including but not limited to common stains, such as Gram staining, acid-fast staining of the biological sample, lactophenol cotton blue staining of the biological sample, Wright's stain of the biological sample, Giemsa stain of the biological sample, and/or trichrome staining of the biological sample.

According to a second aspect, there is provided a method for in-line holographic imaging of a biological sample for automated generation of a representation of the biological sample for phenotypic analysis of a pathological process, said method comprising: arranging a sample carrier carrying the biological sample in an imaging position; illuminating the biological sample using light of at least three different wavelengths from one or more light sources; detecting a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and processing the detected plurality of interference patterns to combine information of the interference patterns based on known spectral characteristics of illumination light for improving resolution compared to individual interference patterns and generating multi-spectral representation of the biological sample with the improved resolution.

Effects and features of this second aspect are largely analogous to those described above in connection with the first aspect. Embodiments mentioned in relation to the first aspect are largely compatible with the second aspect.

The method allows generating of multi-spectral representation of the biological sample in a very fast manner. Thanks to using in-line holographic imaging, a wide field of view may be imaged. Hence, an entire biological sample may be imaged very quickly to generate multi-spectral representation of the biological sample that may be used for analysis of a pathological process.

The use of the at least three different wavelengths allows acquiring a representation of the biological sample with a sufficient spatial resolution for performing analysis of the pathological process. Also, the use of the at least three different wavelengths allows acquiring spectral information such that a spectral resolution may be acquired corresponding to conventional microscopy imaging of biological samples.

Hence, diversity in wavelengths is used both for providing a high quality spatial resolution and a high quality spectral resolution. For instance, using only a limited number of detected interference patterns, a representation of the biological sample may be obtained which corresponds to or outperforms quality of microscopic imaging (while providing imaging of a much larger field of view).

According to an embodiment of the second aspect, the method is used for automated generation of a representation of the biological sample for infection analysis.

In other words, according to the embodiment, there is provided a method for in-line holographic imaging of a biological sample for automated generation of a representation of the biological sample for infection analysis, said method comprising: arranging a sample carrier carrying the biological sample in an imaging position; illuminating the biological sample using light of at least three different wavelengths from one or more light sources; detecting a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and processing the detected plurality of interference patterns to combine information of the interference patterns based on known spectral characteristics of illumination light for improving resolution compared to individual interference patterns and generating multi-spectral representation of the biological sample with the improved resolution.

According to an embodiment, said illuminating and detecting is performed to generate a plurality of multi-spectral representations for a plurality of fields of view of the biological sample.

Even though the in-line holographic imaging allows a large field of view to be imaged, the method may use a plurality of fields of view for representing the entire biological sample.

The plurality of multi-spectral representations representing the plurality of fields of view may be generated in an automated manner requiring no human intervention. The plurality of multi-spectral representations may be acquired simultaneously using an array of sensors or sequentially using a mechanical scanning stage for causing a relative movement between the biological sample and a photo-sensitive detector for detecting the plurality of interference patterns.

According to an embodiment, the method further comprises reconstructing a multi-spectral image of the biological sample and generating a plurality of high-power fields of view for presentation to an operator.

This implies that the method outputs an image that may be displayed and reviewed by the operator, such as a CLS. Thus, the method may be configured to quickly generate and output the multi-spectral image, for example to generate and output the multi-spectral image that is needed by the CLS for analyzing the biological sample for infections.

According to an embodiment, the method further comprises processing the multi-spectral representation of the biological sample for verifying a quality of the biological sample.

This implies that the method may verify quality of the biological sample such that unnecessary processing of the biological sample may be avoided if the quality of the biological sample is inadequate. The quality may be verified before further processing of the plurality of interference patterns detected for the biological sample is performed, e.g., such that an image reconstructed from the plurality of interference pattern need not be generated.

According to an embodiment, the method further comprises, in response to the biological sample failing verification of quality, rejecting the biological sample from further processing.

Thus, if the biological sample fails verification of quality, no further processing of the biological sample, or of the plurality of interference patterns of the biological sample need to be performed. The method may allow processing resources and time to be saved for biological samples being rejected from further processing.

However, the biological sample being rejected may further be confirmed by a human operator, which may be notified that the biological sample potentially is of inadequate quality such that the human operator may confirm the biological sample being rejected. Thus, if the biological sample is incorrectly determined to fail verification of quality, the human operator may overrule the rejecting of the biological sample, and may analyze the biological sample, e.g., using manual handling in a conventional microscope.

It should be realized that quality may be verified based directly on the plurality of interference patterns, but the quality may alternatively or additionally be verified based on the multi-spectral representation of the biological sample, such as based on a reconstructed image.

According to an embodiment, the imaging system or the method is configured to automatically report a non-interpretable sample.

This implies that a sample may be quickly and automatically rejected. The imaging system may be configured to provide the automatic report by the processor being configured to process the representation of the biological sample.

For example, for some sample types, a non-interpretable sample may comprise excessive presence of squamous epithelial cells, excessive staining of background, excessive areas of thick smearing (non-monolayer). According to another example, a non-interpretable sample may correspond to absence of the sample in the representation.

As another example, a non-interpretable sample may be determined based on objects of the biological sample not being adequately stained, which may be referred to as discoloration.

According to an embodiment, the imaging system or the method is configured to automatically select high-power fields of view of the biological sample.

The imaging system may thus be configured to automatically extract fields of view that may be used in further analysis. The imaging system may be configured to automatically select the high-power fields of view from analysis of information acquired by a full sensor comprising an array of photo-sensitive areas. The processor may be configured to process the representation of the biological sample for automatically selecting the high-power fields of view.

According to an embodiment, the imaging system or the method is configured to output the automatically selected high-power fields of view for further analysis. The further analysis may be performed within the imaging system, such as by the processor, or may be performed externally.

For example, a selection criterion for selecting a high-power field of view may be such that selected high-power fields of view comprise mostly bacterial or fungal cells in monolayer and may further comprise no interfering biological or staining artifacts.

According to an embodiment, the imaging system or the method is configured to automatically determine whether selected high-power fields of view present contribution to a pathological process.

Thus, the imaging system or the method may provide output, which may be useful for a CLS, whether the selected high-power fields of view provide an indication of a pathological process.

For example, the selected high-power fields of view may comprise no infection causing agents, such as bacteria or yeast. In another example, concentration of bacteria or yeast is below a clinical threshold.

According to an embodiment, the imaging system or the method is configured to, for selected high-power fields of view, automatically quantify host cells, such as polymorphonuclear and epithelial cells.

The imaging system or the method may be configured to automatically quantify the host cells per high-power field of view, such as given by the following guidelines:
1+ (rare): <1 cell;
2+ (few): 1-5 cells;
3+ (moderate): 6-10 cells; and
4+ (many): >10 cells.

According to an embodiment, the imaging system or the method is configured to, for selected high-power fields of view, automatically quantify pathogens, such as bacteria and yeast.

The imaging system or the method may be configured to automatically quantify the pathogens per high-power field of view, such as given by the following guidelines:
1+ (rare): <1 cell;
2+ (few): 2-10 cells;
3+ (moderate): 11-50 cells; and
4+ (many): >50 cells.

According to an embodiment, the imaging system or the method is configured to, for selected high-power fields of view, automatically report morphologies of bacterial and yeast cells.

The imaging system or the method may be configured to report morphologies among but not limited to the following group of morphologies:
cocci, such as single, pairs, tetrads, chains, clusters;
rods;
spores; and
branching.

The group of morphologies may include branching only when morphologies of yeast cells is to be reported.

According to an embodiment, the imaging system or the method is configured to, for selected high-power fields of view, automatically report positive or negative Gram status, or yeast, per class of pathological agent identified.

### BRIEF DESCRIPTION OF THE DRAWINGS

The above, as well as additional objects, features, and advantages of the present inventive concept, will be better understood through the following illustrative and non-limiting detailed description, with reference to the appended drawings. In the drawings like reference numerals will be used for like elements unless stated otherwise.

FIG. 1 is a schematic view of an imaging system according to an embodiment.

FIG. 2 is a schematic view of a photo-sensitive detector of the imaging system according to an embodiment.

FIG. 3 is a flow chart of a method according to an embodiment.

### DETAILED DESCRIPTION

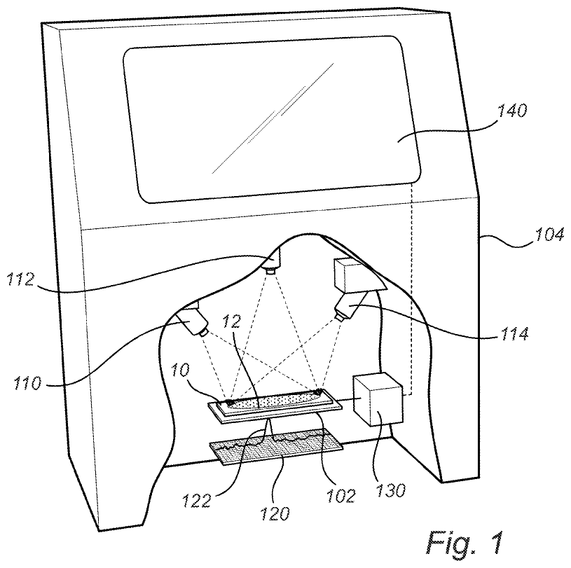

Referring now to FIG. 1, an imaging system 100 according to an embodiment will be described. The imaging system 100 is configured to perform in-line holographic imaging of a biological sample 12.

The imaging system 100 will mainly be described below in relation to generating representations of the biological sample 12 for infection analysis. However, it should be realized that the imaging system 100 need not necessarily be used for generating representations of biological samples 12 for infection analysis. Rather, the imaging system 100 may in other embodiments be configured to generate representations of the biological sample 12 suitable for other types of phenotypic analyses of a pathological process.

The imaging system 100 comprises a receptacle 102, which is configured to receive a sample carrier 10 carrying the biological sample 12. The receptacle 102 may be shaped so that the sample carrier 10 may fit tightly within the receptacle 102 such that the receptacle 102 may define a position of the sample carrier 10 in the receptacle 102. Alternatively, the receptacle 102 may comprise engagement elements for engaging with the sample carrier 10 and define the position of the sample carrier 10 in the receptacle 102.

The receptacle 102 may be positioned in relation to an imaging position of the imaging system 100 such that the biological sample 12 may be appropriately positioned by the receptacle 102 in the imaging position of the imaging system 100. Thus, the receptacle 102 may control that the biological sample 12 is appropriately positioned when imaging of the biological sample 12 is to be performed.

The receptacle 102 may be movable. Thus, the receptacle 102 may be movable between a receiving position, in which the receptacle may be arranged to facilitate placing of the sample carrier 10 in the receptacle 102, and the imaging position. Also, the receptacle 102 may be movable in order to allow the biological sample 12 to be moved in the imaging position such that different fields of view of the biological sample 12 may be imaged in the imaging position.

The imaging device 100 may comprise a plurality of light sources 110, 112, 114. Each light source 110, 112, 114 may be configured to generate a unique wavelength of light, such that the different light sources generate different wavelengths. However, it should be realized that a single light source may be used for generating at least some of the plurality of wavelengths, e.g., by tuning a wavelength output by the single light source.

The light sources 110, 112, 114 may be implemented as laser light sources and/or light emitting diodes (LEDs) configured to output light through a pinhole for generating at least partially spatially coherent light.

The light sources 110, 112, 114 are shown in FIG. 1 as illuminating the biological sample 12 from different directions. Thus, an angular relation between a center axis of a light beam from a light source and a normal to a plane in the imaging position may differ for different light sources 110, 112, 114. However, it should be realized that at least some of the light sources 110, 112, 114 may be configured to illuminate the biological sample 12 from a common direction.

The light sources 110, 112, 114 may be configured to generate illumination light in a visible range of electromagnetic spectrum. However, it should be realized that wavelengths outside the visible range may be used, such as wavelengths corresponding to ultraviolet light and/or infrared light.

Generating a multi-spectral representation of the biological sample 12 which may be adapted to human perception may be facilitated by the light sources 110, 112, 114 being configured to generate illumination light of at least three wavelengths in the visible range, even if further wavelengths outside the visible range may additionally be used.

The light sources 110, 112, 114 may provide a well-defined relationship to the imaging position. For instance, the light sources 110, 112, 114 and the receptacle 102 may be fixedly mounted in a common housing 104. This implies that different relationships of illumination light of different wavelengths to the imaging position may be used for recovering phase information of detected light.

The imaging system 100 may be configured to illuminate the biological sample 12 such that part of the illumination light is scattered by the biological sample 12 forming scattered illumination light and part of the illumination light passes unaffected through the biological sample 12 forming non-scattered illumination light.

The imaging system 100 further comprises a photo-sensitive detector 120. The photo-sensitive detector 120 may be arranged in relation to the imaging position, e.g., by being mounted in the common housing 104, such that both scattered illumination light and non-scattered illumination light may reach the photo-sensitive detector 120. The photo-sensitive detector 120 may thus be arranged relatively close to the imaging position.

The scattered illumination light and the non-scattered illumination light form an interference pattern 122 on the photo-sensitive detector 120. The photo-sensitive detector 120 may comprise an array of photo-sensitive areas such that the photo-sensitive detector 120 may be configured to detect a distribution of light intensity over an overall area of the photo-sensitive detector 120 based on individual intensity values detected by respective photo-sensitive areas in the array. For instance, the photo-sensitive detector 120 may be implemented as an image sensor, such as a complementary metal-oxide-semiconductor (CMOS) image sensor.

The wavelengths of illumination light may be sequentially used for illuminating the biological sample 12. Thus, the photo-sensitive detector 120 may sequentially detect a plurality of interference patterns 122, each being based on a single wavelength of illumination light. Alternatively, different photo-sensitive areas of the photo-sensitive detector 120 may be sensitive to different wavelengths, e.g., by being associated with different filters. The different photo-sensitive areas may be arranged in a mosaic structure, such that the photo-sensitive detector 120 may simultaneously detect a plurality of interference patterns for different wavelengths.

The imaging system 100 further comprises a processor 130. The processor 130 is configured to receive the plurality of interference patterns 122 detected by the photo-sensitive detector 120. The processor 130 is further configured to process the plurality of interference patterns 122 for generating a representation of the biological sample 12.

The imaging system 100 is configured to generate a plurality of interference patterns 122 based on a plurality of wavelengths of illumination light. The imaging system 100 may be configured to acquire a single interference pattern 122 per wavelength for a single field of view of the biological sample 12.

The imaging system 100 is further configured to generate a multi-spectral representation of the biological sample 12. The multi-spectral representation of the biological sample 12 provides information of the biological sample 12 in a plurality of spectral channels. The plurality of spectral channels may correspond to the plurality of wavelengths of illumination light, such that each wavelength of illumination light is used for generating a corresponding spectral channel in the multi-spectral representation of the biological sample 12. However, some of the wavelengths of illumination light may be used for providing additional information of the biological sample 12 so as to improve content in the spectral channels in the multi-spectral representation even though the multi-spectral representation does not comprise a spectral channel corresponding to such wavelength(s).

Thanks to the interference patterns 122 being based on different wavelengths, there is diversity in phase information of the interference patterns 122. Even though the photo-sensitive detector 120 may not be able to detect phase information in the interference patterns 122, the phase information may be retrieved by processing the interference patterns 122 and a quality of the retrieved phase information may be improved by combining a plurality of interference patterns 122.

The processor 130 may be configured to apply an algorithm for diffraction propagation approximation and/or iterative phase retrieval to determine a representation of the biological sample 12. The interference patterns 122 of different wavelengths provide complementary information on the biological sample 12, which may be combined by an algorithm for improving resolution of the representation of the biological sample 12. For instance, iterative phase retrieval may include simulating forward- and backward-propagation of light between an image plane defined by the photo-sensitive detector 120 and an object plane of the biological sample 12. Using several interference patterns 122 in the forward- and backward-propagation of light, resolution of the representation of the biological sample 12 may be improved such that a super-resolution, i.e., a spatial resolution of the biological sample 12 beyond resolution of the photo-sensitive areas of the photo-sensitive detector 120 may be achieved.

The processor 130 may use the known spectral characteristics of the illumination light, when combining the interference patterns 122, since differences in spectral characteristics affect the propagation of light. By taking the spectral characteristics into account, propagation of light for different wavelengths may be combined in order to improve spectral and spatial resolution of the representation of the biological sample 12.

If different angular relations of illumination light to the biological sample 12 are used, the known angular relations may also be taken into account for simulating propagation of light between the image plane and the object plane.

The processor 130 may be configured to perform image reconstruction such that an image of the biological sample 12 is determined based on the plurality of interference patterns 122 and the processor 130 may then output the reconstructed image of the biological sample 12 as a representation of the biological sample 12. However, the processor 130 may alternatively be configured to determine phase information and may output phase and intensity information, which may not necessarily correspond to an actual reconstructed visual representation of the biological sample 12.

The imaging system 100 may be configured to use at least three different wavelengths for illuminating the biological sample 12. Three wavelengths may be used for generating a multi-spectral representation of the biological sample 12 which may be used for performing infection analysis. However, the imaging system 100 may preferably be configured to use more than three different wavelengths for illuminating the biological sample 12. The processor 130 may combine the interference patterns 122 based on the known spectral characteristics of illumination light for more than three wavelengths for improving spatial resolution and spectral resolution of the representation of the biological sample 12.

The multi-spectral representation may include at least three wavelength channels in order to enable a color image to be generated. Thus, the multi-spectral representation may for instance comprise red, green, and blue channels for providing an RGB representation of the biological sample 12. However, by using further spectral channels, a larger color space may be spanned by the multi-spectral representation for improving a color reproduction of the multi-spectral representation. For instance, the multi-spectral representation may form true-color reproduction facilitating visual analysis or verification of the biological sample.

A fourth and following additional wavelength of illumination light may be used for improving spatial resolution of the biological sample 12 without including the additional wavelength(s) in the multi-spectral representation. However, the additional wavelength(s) may also be included in the multi-spectral representation of the biological sample 12.

According to an embodiment, the light sources 110, 112, 114 are configured to generate illumination light of at least five different wavelengths. Hence, at least five light sources may be used, although only three light sources 110, 112, 114 are illustrated. Using at least five different wavelengths may allow a high quality representation of the biological sample 12 to be generated. However, it should be realized that, by adding further wavelengths, quality of the multi-spectral representation may be only slightly increased per added wavelength, such that the imaging system 100 may preferably use 5-7 different wavelengths.

In an embodiment, seven apertures, e.g., associated with seven light sources, may be used for illuminating the biological sample 12. The seven light sources may include several light sources providing the same wavelength, for creating a super-resolved representation of the biological sample 12 while the other light sources may provide spectral information. For instance, a set-up using 4 laser diodes emitting light of a wavelength of 405 nm may be used together with laser diodes emitting light of a wavelength of 470 nm, 520 nm, and 640 nm, respectively.

In another embodiment, six apertures, e.g., associated with six light sources, may be used for illuminating the biological sample 12. The six light sources may emit light of a wavelength of 405 nm, 450 nm, 470 nm, 520 nm, 590 nm and 640 nm, respectively. The light sources may be implemented as laser diodes, except for the light source emitting a wavelength of 590 nm, since there is no inexpensive solution for providing a laser with such wavelength. Instead, a light emitter based on a microLED chip may be used for the 590 nm wavelength.

The multi-spectral representation of the biological sample 12 may include fewer wavelengths than the number of wavelengths of the illumination light. It should be realized that use of a large number of wavelengths in the multi-spectral representation may not be necessary in order to enable sufficient quality of the multi-spectral representation for infection analysis.

The imaging system 100 may be adapted for providing a multi-spectral representation of a biological sample 12 that is suited for infection analysis. The imaging system 100 may thus be configured to generate representations of the biological sample 12, by the processor 130 being configured to reconstruct a multi-spectral image of the biological sample 12, which is to be used by an operator for obtaining an analysis result. The imaging system 100 may thus, once a biological sample 12 is presented to the imaging system 100, automatically generate the representations needed for infection analysis. The imaging system 100 may be configured to generate a plurality of fields of view based on the reconstructed image. These fields of view may then be presented to the operator in order to allow the operator to perform infection analysis.

The imaging system 100 may thus further comprise a display 140 which may be configured to present image(s) of the biological sample 12 to the operator. The display 140 may be connected to the processor 130 for receiving a reconstructed image for output on the display 140.

It should be realized that numerous methods of infection analysis involve following a particular protocol in analyzing several parts of the biological sample 12 in order to generate a report as result of infection analysis. Thanks to the imaging system 100 enabling automated generation of images needed to be analyzed, the operator may be quickly presented with the images needed and may not need to manually perform tedious work to obtain images of a plurality of parts of the biological sample 12 at different resolutions.

However, it should be realized that the imaging system 100 does not necessarily output a reconstructed image of the biological sample 12. Rather, a different level of processing of the interference patterns 122 may be output. The multi-spectral representation of the biological sample 12 may be used for analysis by a human operator or for analysis by a processor for computer-based determination of an analysis result.

As an alternative to the set-up shown in FIG. 1, the imaging system 100 may comprise a single-aperture multi-color light source. This light source may be implemented using single-mode optical fibers, fused fiber combiners and pigtailed laser diodes packaged such that light emitted by the laser diodes is coupled directly within a package into a single-mode fiber. The light propagating in fibers may then be combined into a single fiber from which illumination of the biological sample 12 is provided.

This alternative may provide an easy assembly of the light source in the imaging system 100. Since a single aperture provides illumination for all wavelengths of illumination light, processing of interference patterns for generating multi-spectral representation of the biological sample may be relatively simple and fast.

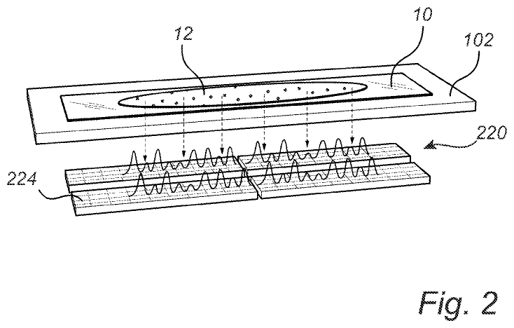

As another alternative, the imaging system 100 may use a multi-aperture fiber set-up. In such case, fiber couplers may be used for splitting a combined multi-color illumination spot, as described in the above alternative, into multiple multi-color spots. This implies that multiple illumination spots may be provided, each associated with a different sensor of an array of sensors (as shown and discussed below in relation to FIG. 2).

The single-aperture multi-color light source may alternatively be implemented using waveguides, such as integrated waveguides formed on a substrate. The integrated waveguides may be configured to combine the colors and may receive input from multiple diodes that may be positioned to directly couple light into an input of the waveguide.

Such alternative may be associated with a lower cost compared to using fiber optics. The use of integrated waveguides allows integration of the light source with multiple diodes into a very small package. Also, precise positions of output aperture(s) may be defined using a semiconductor process for creating light source with integrated waveguides.

As yet another alternative, a super-resolution multi aperture system may be based on a microLED or nanoLED array of light sources. A microLED array may for example be realized as a micro display which is typically used for display applications. MicroLED light sources may typically have an emitting aperture of a size of 50 μm, whereas nanoLED light sources may have an emitting aperture of a size of 1-5 μm. Such small apertures allow the light sources to be used for holographic imaging. Using a two-dimensional array of such light sources may provide a multitude of apertures enabling an angular diversity to be acquired in detected interference patterns. This may be used for generating a super-resolved representation of the biological sample.

Such a super-resolution multi aperture system may alternatively be based on a tunable microLED display. In such case, the wavelength of light emitted by each individual LED in the array may be tuned. This may provide a large plurality of apertures for illumination with continuous color tuning per aperture, facilitating generation of super-resolved multi-spectral representation of the biological sample 12.

The diodes may advantageously be scaled to provide an emitting aperture of a size of less than 10 μm to provide good spatial confinement and spatial coherence of the emitted light.

Such light source may be tuned to use specific spectral lines needed to differentiate specific stains and samples. The light source may use different settings optimized for different types of samples. The imaging system 100 may be configured to select a number of apertures and colors that is to be used for a desired analysis, wherein resolving power and accuracy of analysis may be weighed against a number of interference patterns to be detected and complexity of processing of the interference patterns.

The imaging system 100 is configured to generate representations of the biological sample 12 suitable for particular infection analysis. The imaging system 100 may be adapted to receive a biological sample 12 that has been prepared in a particular manner for enabling infection analysis. Thus, the imaging system 100 may be configured to provide illumination light of wavelengths suited for the preparation of the biological sample 12, e.g., wavelengths corresponding to colors of stains used in preparation of the biological sample 12.

The imaging system 100 may be configured to receive input identifying a type of staining of the biological sample 12. The imaging system 100 may further be configured to receive input identifying a type of infection analysis to be performed or otherwise identifying a desired output from the imaging system 100.

The imaging system 100 may comprise a control unit for controlling functionality of the imaging system 100. The control unit may be configured to control which wavelengths of illumination light to be used for imaging of the biological sample 12 in dependence of input of type of staining and/or input identifying a type of infection analysis to be performed. Also, the control unit may be configured to control the multi-spectral representations of the biological sample 12 to be output, such as controlling a number of fields of view to be imaged or a number of fields of view to be output.

The imaging system 100 may be configured to receive the input for controlling the generation of representations of the biological sample through a user interface. However, the imaging system 100 may alternatively comprise a barcode reader for reading a barcode on the sample carrier 10 providing the input to the imaging system 100. The barcode may also identify the biological sample 12.

The biological sample 12 may be arranged on a sample carrier 10, for instance a microscope slide, and may be dried and/or stained with any of a plurality of stains including but not limited to Gram stain, acid fast stain, lactophenol cotton blue stain, Wright's stain, Giemsa stain, and trichrome staining. These stains may be used for biological samples for which infection analysis is to be performed. However, it should be realized that the biological sample 12 may alternatively be stained with any of a plurality of stains including but not limited to hematoxylin and eosin stain, Papanicolau stain, and chromogenic immunohistochemistry antibody stain, such as human epidermal growth factor receptor 2 (HER2) and antigen Kiel 67 (Ki-67). These stains may be used for analysis of presence of cancerous cells.

The imaging system 100 may be configured to generate images of the biological sample 12 which an operator for performing infection analysis would be accustomed to using. For instance, the imaging system 100 may be configured to generate representations of the biological sample 12 for imaging of the biological sample 12 using Gram staining of the biological sample 12.

For instance, the imaging system 100 may be configured to provide images used for infection analysis to detect any of Gram positive bacilli, Gram negative bacilli, Gram positive cocci, Gram negative cocci, yeast, or filamentous fungi.

The imaging system 100 may facilitate identification of bacteria or other cells organized in singles, pairs, tetrads, clusters, chains or in a Chinese letter arrangement, or identification of unique shapes, such as shapes of spirochete bacteria.

The imaging system 100 may be used for infection analysis of any of a plurality of host cells including but not limited to polymorphonuclear leukocytes (PMNs), erythrocytes, leukocytes (white blood cells) including myelocytes (neutrophils, macrophages, eosinophils, mast cells, basophils, dendritic cells) and lymphocytes (T cells, B cells, NK cells), epithelial cells and squamous cells. The imaging system may be used for analysis of size, shape, and/or spatial organization of cells.

The imaging system 100 may be used for infection analysis for identifying parasites and their ova.

The imaging system 100 may be used for infection analysis for acid-fast bacillus (AFB) tests for identifying absence or presence and quantity of mycobacteria in the biological sample 12.

The imaging system 100 may be used for infection analysis for identifying an interaction of bacteria with a host cell, such as identifying intracellular vs extracellular interaction, or identifying inflammation (presence/relationship of immune cells to pathogens).

The imaging system 100 may be used for infection analysis for determining patterns or etiology of target cells, such as normal flora, mixed infections, mixed infection suggestive of anaerobes and mixed infection of aerobic bacteria.

The imaging system 100 may be configured to, before generating a multi-spectral representation of the biological sample 12 or before further processing the multi-spectral representation, verify a quality of the biological sample 12 and/or verify a quality of staining of the biological sample 12 (if the biological sample 12 is stained).

By verifying quality, the processor 130 may identify biological samples 12 that are of inadequate quality for providing a reliable analysis result. Hence, such biological samples 12 may be rejected from further processing in order to save processing resources and time spent by the imaging system 100, and also save time spent by an operator on analyzing the biological sample 12.

The processor 130 may be configured to identify if there is insufficient amount of biological material in the biological sample 12 and/or identify if the biological sample 12 is too concentrated.

For instance, if smear preparation of the biological sample 12 on a microscope slide is poor, significant loss of biological material may occur. In such case, an operator would normally reject the biological sample 12. The imaging system 100 may be configured to identify a rejection of the biological sample 12. For instance, if amount of biological material is low, intensity of interference patterns 122 may be low such that the processor 130 may be configured to identify inadequate quality of the biological sample 12 based merely on an intensity or distribution of detected light by the photo-sensitive detector 120.

Hence, the processor 130 may be configured to verify quality of the biological sample 12 and/or identifying that the biological sample 12 fails verification of quality, before the multi-spectral representation of the biological sample 12 is generated.

The processor 130 may further be configured to compare the detected interference patterns 122 to a calibration standard stored in the imaging system 100 for verifying a quality of staining of the biological sample 12. The spectral content of the interference patterns 122 may be compared to the calibration standard for determining whether the spectral content correspond to color(s) of a stain used for staining of the biological sample 12.

Hence, the processor 130 may be configured to verify quality of staining of the biological sample 12 and/or identifying that the biological sample 12 fails verification of quality of staining, before the multi-spectral representation of the biological sample 12 is generated.

The processor 130 may be configured to generate a semi-quantitative score such as a score based on the Q Score system, which assigns levels of presence of polymorphonuclear cells (PMNs) and squamous epithelial cells (SECs) in the sample as low (Q0), moderate (Q1, Q2), or high (Q3) quality, representing biological sample preparation as feedback to the operator or as a measure for automatic rejection of the biological sample 12 for purposes of interpretation of the biological sample 12. For instance, an equivalent of a Q Score of Q0 of a wound sample or a sputum sample reported by the processor 130, can be used as an indication for rejecting the sample from diagnostic consideration.

Referring now to FIG. 2, the imaging system 100 may be configured to generate multi-spectral representations for a plurality of fields of view of the biological sample 12.

It may be important to analyze an entire area of the biological sample 12 or at least portions representative of the biological sample 12, wherein the portions are distributed over the area of the biological sample 12.

Although the in-line holographic imaging allows imaging of a large field of view, the field of view is limited by a size of the photo-sensitive detector 120. The biological sample 12 may be arranged in such a large area that the entire biological sample 12 may not be simultaneously imaged onto a standard size photo-sensitive detector 120, such as a CMOS image sensor.

According to the embodiment shown in FIG. 2, the imaging system 100 may comprise a photo-sensitive detector 220 comprising an array of sensors 224. Each sensor 224 may be formed by an array of photo-sensitive areas for detecting light intensity for a respective field of view. For instance, each sensor 224 may be formed by a CMOS image sensor.

The sensors 224 may be arranged in close relation to each other so as to enable imaging of virtually the entire or almost entire biological sample 12 simultaneously. Each sensor 224 may image a respective portion of the biological sample 12 forming a respective field of view.

This implies that the entire biological sample 12 may be very quickly imaged. The light sources 110, 112, 114 may be configured to generate illumination light in respective light beams having a cross-section covering the entire biological sample 12 such that the entire biological sample 12 may be simultaneously illuminated using a single light source per wavelength. However, it should be realized that the imaging system 100 may alternatively comprise an array of light sources (not shown) for enabling each portion of the biological sample 12 to be illuminated simultaneously by the same wavelength.

As an alternative to using an array of sensors 224, the imaging system 100 may comprise a mechanical scanning stage for providing a relative movement between the biological sample 12 and the photo-sensitive detector 120, e.g., by the mechanical scanning stage being configured to move the receptacle 102 or the sample carrier 10 in the receptacle 102 or to move a substrate on which the photo-sensitive detector 120 is arranged. Thus, interference patterns 122 for different fields of view of the biological sample 12 may be acquired in a sequence with a movement caused by the mechanical scanning stage between detection of each field of view in the sequence.

It should be realized that the imaging system 100 may be configured to automatically determine suitable fields of view of the biological sample 12 so as to allow acquisition of fields of view that are suitable for analysis. Thus, the imaging system 100 may be configured to provide a dynamic selection of parts of the biological sample 12 to be in focus for the automated generation of representations of the biological sample 12.

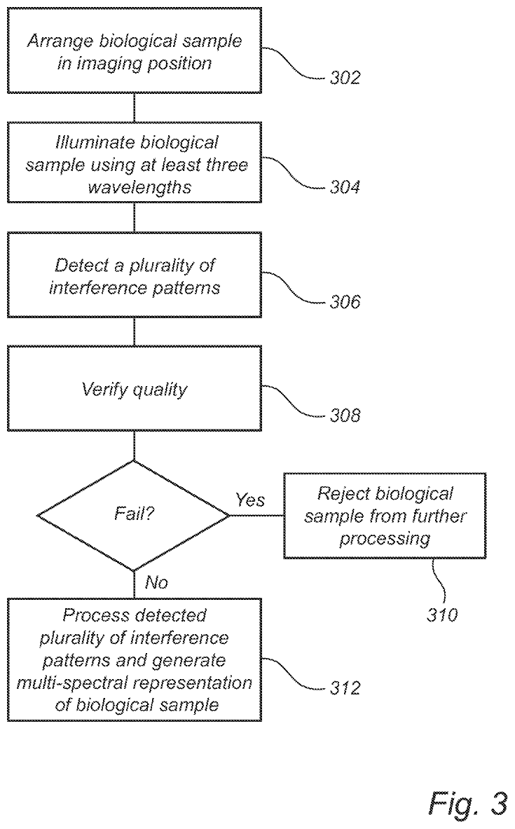

Referring now to FIG. 3, a method for in-line holographic imaging of a biological sample 12 will be described.

The biological sample 12 may be deposited onto a sample carrier 10, such as a microscopic slide, by conventional droplet or smear techniques. The biological sample 12 may be unprocessed, concentrated, cleaned, or otherwise prepared for imaging. Preparation of the biological sample 12 may not differ for in-line holographic imagine compared to imaging using conventional microscopy.

The biological sample 12 may be dried and/or stained on the sample carrier 10 with any of a plurality of stains including but not limited to Gram stain, acid fast stain, lactophenol cotton blue stain, Wright's stain, Giemsa stain, trichrome staining, hematoxylin and eosin staining, Papanicolau staining, and chromogenic immunohistochemistry antibody staining, such as using HER2 and Ki-67.

The biological sample 12 may be covered, e.g., by a thin coverslip, in order to protect the biological sample 12.

The biological sample 12 may constitute a wet mount, stained or unstained, covered by a coverslip.

The sample carrier 10 may be labeled with one or more barcodes that may identify the biological sample 12 and type of staining used.

The prepared biological sample 12 may then be presented to the imaging system 100 for allowing automated generation of representations of the biological sample 12. The sample carrier 10 may be loaded into the imaging system 100 by placing the sample carrier 10 in a receptacle 102. The sample carrier 10 carrying the biological sample 12 may thus be arranged 302 in an imaging position.

The imaging system 100 may then read the barcode in order to obtain input for controlling the generation of representations of the biological sample 12.

The method further comprises illuminating 304 the biological sample 12 using light of at least three different wavelengths from one or more light sources 110, 112, 114. The wavelengths used may be selected by a control unit based on the input through the barcode.

The method further comprises detecting 306 a plurality of interference patterns 122 formed by interference between scattered illumination light, being scattered by the biological sample 12, and non-scattered illumination light passing through the biological sample 12. Each of the plurality of interference patterns 122 is based on a respective wavelength of the at least three different wavelengths.

The illuminating 304 and detecting 306 may be performed for a plurality of fields of view of the biological sample 12. This may be achieved using an array of sensors 224 or using a mechanical stage for moving the biological sample 12 in relation to the photo-sensitive detector 120 or by using a combination of the above. A number of fields of view may be controlled by the control unit based on the input through the barcode.

The method may further comprise verifying 308 a quality of the biological sample 12 and/or verifying a quality of staining of the biological sample 12. The method may further comprise, if the verification of quality of the biological sample 12 and/or the verification of quality of staining fails, rejecting 310 the biological sample 12 from further processing. Thus, no further processing of the detected interference patterns 122 may be necessary. An indication to the operator of the imaging system 100 that the verification of quality has failed may be provided, such that the verification may be confirmed by the operator.

The method further comprises processing 312 the detected plurality of interference patterns 122 to combine information of the interference patterns 122 based on known spectral characteristics of illumination light for improving resolution compared to individual interference patterns 122 and generating multi-spectral representation of the biological sample 12 with the improved resolution. The processing may use the information from the interference patterns 122 based on a plurality of wavelengths to generate a high quality representation of the biological sample 12.

The processing may generate a plurality of multi-spectral representations for the plurality of fields of view of the biological sample 12.

The processing may be configured to reconstruct a multi-spectral image for each field of view of the biological sample. The multi-spectral image may provide a super-resolution image, having a higher spatial resolution than a resolution of pixels of the photo-sensitive detector 130. The multi-spectral image may further provide high fidelity color information based on the multi-spectral information of plurality of wavelengths used for generating the interference patterns 122.

The multi-spectral image for each field of view may further be processed for sharpening, denoising or using other image processing techniques to prepare the multi-spectral image for presentation to the operator.

The processing may further be configured to generate a plurality of fields of view for presentation to the operator.

The imaging system 100 may finally generate a report for the biological sample 12 identifying targets of interest, which may be based on input from operator review of the multi-spectral representations of the biological sample 12. The report of the biological sample 12 may further comprise other qualities of the biological sample 12. Other qualities of the biological sample 12 may include but are not limited to quality of staining, quality of the biological sample 12, quality of preparation (such as appropriate/inappropriate thickness of material), and/or contextual clinical information.

In the above the inventive concept has mainly been described with reference to a limited number of examples. However, as is readily appreciated by a person skilled in the art, other examples than the ones disclosed above are equally possible within the scope of the inventive concept, as defined by the appended claims.

What is claimed is:

1. An imaging system for in-line holographic imaging of a biological sample on a sample carrier for automated generation of a representation of the biological sample for phenotypic analysis of a pathological process, the imaging system comprising:
one or more light sources configured to generate illumination light of at least three different wavelengths;
a receptacle for receiving the sample carrier in an imaging position;
wherein the one or more light sources are configured to illuminate the biological sample by the generated illumination light in the imaging position;
a photo-sensitive detector configured to detect a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and
a processor, which is configured to receive the plurality of interference patterns, wherein the processor is configured to combine information of the interference patterns based on known spectral characteristics of illumination light for improving resolution compared to individual interference patterns and generate multi-spectral representation of the biological sample with the improved resolution.

2. The imaging system according to claim 1, wherein the processor is configured to combine information of the interference patterns based on known spectral characteristics of illumination light for improving spatial and spectral resolution.

3. The imaging system according to claim 1, wherein the one or more light sources are configured to generate illumination light of a number of wavelengths being at least five wavelengths and wherein the processor is configured to generate multi-spectral representation of the biological sample including fewer wavelengths than the number of wavelengths of the illumination light.

4. The imaging system according to claim 1, wherein the imaging system is configured to generate a plurality of multi-spectral representations for a plurality of fields of view of the biological sample, and wherein the photo-sensitive detector comprises an array of sensors, wherein each sensor in the array is configured to detect the plurality of interference patterns for a respective field of view of the biological sample.

5. (canceled)

6. The imaging system according to claim 1, wherein the processor is configured to reconstruct a multi-spectral image of the biological sample, and wherein the processor is further configured to generate a plurality of high-power fields of view for presentation to an operator.

7. (canceled)

8. The imaging system according to claim 1, wherein the processor is configured to process the representation of the biological sample for verifying a quality of the biological sample.

9. The imaging system according to claim 1, wherein the processor is configured to process the multi-spectral representation of the biological sample for verifying a quality of staining of the biological sample.

10. The imaging system according to claim 1, wherein the imaging system is configured to generate representations of the biological sample for imaging of the biological sample using staining of the biological sample.

11. The imaging system according to claim 1, wherein the imaging system is configured to automatically report a non-interpretable sample.

12. The imaging system according to claim 1, wherein the imaging system is configured to automatically select high-power fields of view of the biological sample, and wherein the imaging system is configured to output the automatically selected high-power fields of view for further analysis.

13. (canceled)

14. The imaging system according to claim 12, wherein the imaging system is configured to automatically determine whether selected high-power fields of view present contribution to a pathological process.

15. The imaging system according to claim 12, wherein the imaging system is configured to, for selected high-power fields of view, automatically quantify host cells, such as polymorphonuclear and epithelial cells, and wherein the imaging system is configured to automatically quantify the host cells per high-power field of view given following guidelines:
1+ (rare): <1 cell;
2+ (few): 1-5 cells;
3+ (moderate): 6-10 cells; and
4+ (many): >10 cells.

16. (canceled)

17. The imaging system according to claim 12, wherein the imaging system is configured to, for selected high-power fields of view, automatically quantify pathogens, such as bacteria and yeast, and wherein the imaging system is configured to automatically quantify the pathogens per high-power field of view given following guidelines:
1+ (rare): <1 cell;
2+ (few): 2-10 cells;
3+ (moderate): 11-50 cells; and
4+ (many): >50 cells.

18. (canceled)

19. The imaging system according to claim 12, wherein the imaging system is configured to, for selected high-power fields of view, automatically report morphologies of bacterial and yeast cells, and wherein the imaging system is configured to report morphologies among following group of morphologies:
cocci, such as single, pairs, tetrads, chains, clusters;
rods;
spores; and
branching.

20. (canceled)

21. The imaging system according to claim 12, wherein the imaging system is configured to, for selected high-power fields of view, automatically report positive or negative Gram status, or yeast, per class of pathological agent identified.

22. A method for in-line holographic imaging of a biological sample for automated generation of a representation of the biological sample for phenotypic analysis of a pathological process, said method comprising:
arranging a sample carrier carrying the biological sample in an imaging position;
illuminating the biological sample using light of at least three different wavelengths from one or more light sources;
detecting a plurality of interference patterns formed by interference between scattered illumination light, being scattered by the biological sample, and non-scattered illumination light passing through the biological sample, wherein each of the plurality of interference patterns is based on a respective wavelength of the at least three different wavelengths; and
processing the detected plurality of interference patterns to combine information of the interference patterns based on known spectral characteristics of illumination light for improving resolution compared to individual interference patterns and generating multi-spectral representation of the biological sample with the improved resolution.

23. The method according to claim 22, wherein said illuminating and detecting is performed to generate a plurality of multi-spectral representations for a plurality of fields of view of the biological sample.

24. The method according to claim 22, further comprising reconstructing a multi-spectral image of the biological sample and generating a plurality of high-power fields of view for presentation to an operator.

25. The method according to claim 22, further comprising processing the multi-spectral representation of the biological sample for verifying a quality of the biological sample.

26. The method according to claim 25, further comprising, in response to the biological sample failing verification of quality, rejecting the biological sample from further processing.
